(19) United States
(12) Patent Application Publication
(10) Pub. No.: US 2022/0261726 A1
(43) Pub. Date: Aug. 18, 2022

(54) METHOD, INFORMATION PROCESSING DEVICE, AND NON-TRANSITORY STORAGE MEDIUM

(71) Applicant: TOYOTA JIDOSHA KABUSHIKI KAISHA, Toyota-shi (JP)

(72) Inventors: Atsushi OKUBO, Nisshin-shi (JP); Kento NITTA, Tokyo (JP); Takaaki KATO, Saitama-shi (JP); Daiki KANEICHI, Tokyo (JP); Minoru NAKADORI, Toyota-shi (JP)

(21) Appl. No.: 17/648,345

(22) Filed: Jan. 19, 2022

(30) Foreign Application Priority Data
Feb. 17, 2021 (JP) 2021-023650

(51) Int. Cl. G06Q 10/06; G06Q 50/06; B60L 53/66; B60L 58/13; G08G 1/09

(52) U.S. Cl. CPC G06Q 10/06315; G06Q 50/06; G08G 1/09; B60L 58/13; B60L 53/66

(57) ABSTRACT

A method to be executed by an information processing device includes: determining whether a state of charge of a first vehicle parked in a parking space provided with charging equipment is equal to or higher than a first threshold; determining whether a future demand for the charging equipment is high based on a predetermined criterion; and outputting an instruction to move the first vehicle from the parking space when determining that the state of charge of the first vehicle is equal to or higher than the first threshold and the future demand for the charging equipment is high.

### CROSS-REFERENCE TO RELATED APPLICATION

This application claims priority to Japanese Patent Application No. 2021-023650 filed on Feb. 17, 2021, incorporated herein by reference in its entirety.

### BACKGROUND

### 1. Technical Field

The present disclosure relates to a method, an information processing device, and a non-transitory storage medium.

### 2. Description of Related Art

As an example of related art, there is a technology related to charging of vehicles including drive batteries, such as electric vehicles (EV) and hybrid vehicles (HV). For example, Japanese Unexamined Patent Application Publication No. 2016-156206 (JP 2016-156206 A) discloses that an EV tray loaded with an EV that has been charged in a charging space is moved to a storage space instead of the charging space.

### SUMMARY

There is room for improvement in the technology related to vehicle charging.

The present disclosure improves the technology related to vehicle charging.

A method according to a first aspect of the present disclosure is executed by an information processing device. The method includes: determining whether a state of charge of a first vehicle parked in a parking space provided with charging equipment is equal to or higher than a first threshold; determining whether a future demand for the charging equipment is high based on a predetermined criterion; and outputting an instruction to move the first vehicle from the parking space when determining that the state of charge of the first vehicle is equal to or higher than the first threshold and the future demand for the charging equipment is high.

An information processing device according a second aspect of the present disclosure includes a controller configured to: determine whether a state of charge of a first vehicle parked in a parking space provided with charging equipment is equal to or higher than a first threshold; determine whether a future demand for the charging equipment is high based on a predetermined criterion; and output an instruction to move the first vehicle from the parking space when determining that the state of charge of the first vehicle is equal to or higher than the first threshold and the future demand for the charging equipment is high.

A non-transitory storage medium according to a third aspect of the present disclosure stores medium storing a program that is executable by a computer and that causes the computer to perform functions including: determining whether a state of charge of a first vehicle parked in a parking space provided with charging equipment is equal to or higher than a first threshold; determining whether a future demand for the charging equipment is high based on a predetermined criterion; and outputting an instruction to move the first vehicle from the parking space when determining that the state of charge of the first vehicle is equal to or higher than the first threshold and the future demand for the charging equipment is high.

According to the above aspects of the present disclosure, the technology related to vehicle charging is improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a schematic configuration of a system according to one embodiment of the present disclosure;

FIG. 2 is a diagram illustrating an example of charging equipment provided in a parking space;

FIG. 3 is a block diagram illustrating a schematic configuration of a vehicle;

FIG. 4 is a block diagram illustrating a schematic configuration of an information processing device; and

FIG. 5 is a flowchart illustrating operations of the information processing device.

### DETAILED DESCRIPTION OF EMBODIMENTS

An embodiment of the present disclosure will be described below.

### Outline of Embodiment

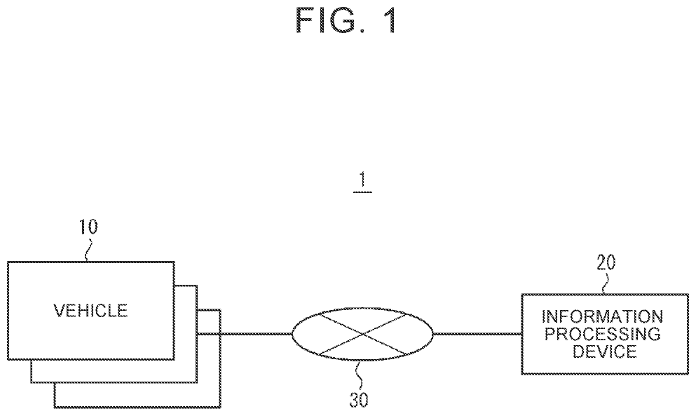

An outline of a system 1 according to the embodiment of the present disclosure will be described with reference to FIG. 1. The system 1 includes vehicles 10 and an information processing device 20. Each vehicle 10 and the information processing device 20 are connected to a network 30 including, for example, the Internet and a mobile communication network so as to be able to communicate with each other.

For example, the vehicle 10 is an automobile, but is not limited to the automobile, and may be any vehicle. Examples of the automobile include, but not limited to, a diesel vehicle, a gasoline vehicle, an EV, an HV, a plug-in hybrid vehicle (PHV), and a fuel cell vehicle (FCV). The vehicle 10 may be driven manually by a driver who is in the vehicle 10 or is remotely performing a driving operation. For example, the vehicle 10 may be capable of autonomous driving at Levels 1 to 5 defined in the Society of Automotive Engineers (SAE). The number of vehicles 10 in the system 1 may be set as appropriate. Examples of users of the vehicle 10 include, but not limited to, a driver, an occupant, a passenger, an owner, and a borrower of the vehicle 10.

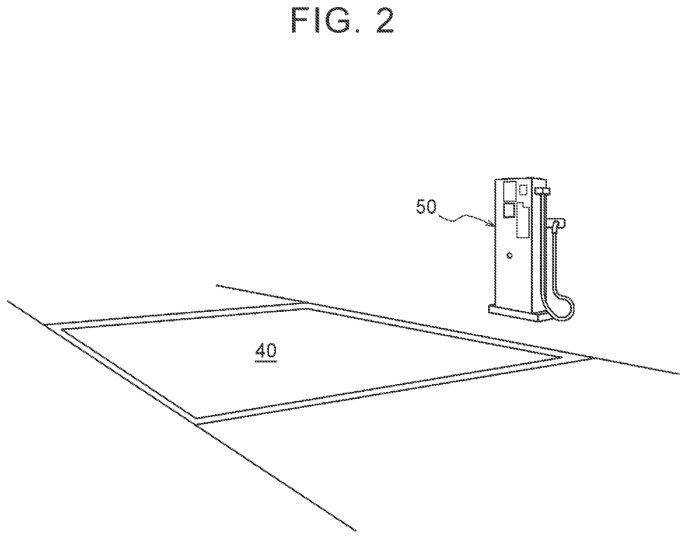

The vehicle 10 includes a secondary battery. For example, the vehicle 10 is chargeable by using charging equipment 50 provided in a parking space 40 illustrated in FIG. 2 while the vehicle 10 is parked in the parking space 40. Charging power can be transferred or received by wire or wireless. For example, the parking space 40 is provided in a parking lot or at the end of a roadway in its width direction, but is not limited to such a place, and may be provided at any place.

For example, the information processing device 20 is a server, but is not limited to the server, and may be any computer. The information processing device 20 can communicate with each vehicle 10 via the network 30. The information processing device 20 can acquire, from each vehicle 10, any information related to the vehicle 10, such as position information of the vehicle 10, a state of charge (SOC) of the vehicle 10, and a destination in route guidance.

First, the outline of the present embodiment will be described, and details will be described below. The information processing device 20 determines whether the SOC of a vehicle 10 parked in the parking space 40 provided with the charging equipment 50 (hereinafter referred to also as “first vehicle 10”) is equal to or higher than a first threshold. The information processing device 20 determines whether a future demand for the charging equipment 50 is high in light of a predetermined criterion. When the information processing device 20 determines that the SOC of the first vehicle 10 is equal to or higher than the first threshold and the future demand for the charging equipment 50 is high, the information processing device 20 outputs an instruction to move the first vehicle 10 from the parking space 40.

According to the present embodiment described above, when the SOC of the first vehicle 10 parked in the parking space 40 is relatively high and the future demand for the charging equipment 50 is high, the first vehicle 10 may be moved from the parking space 40 to a different place. Therefore, the technology related to charging of the vehicles 10 is improved, for example, in that a necessary and sufficient SOC can be secured for the first vehicle 10 and the system can fulfill the future demand for the charging equipment 50.

Next, each configuration in the system 1 will be described in detail.

Configuration of Vehicle

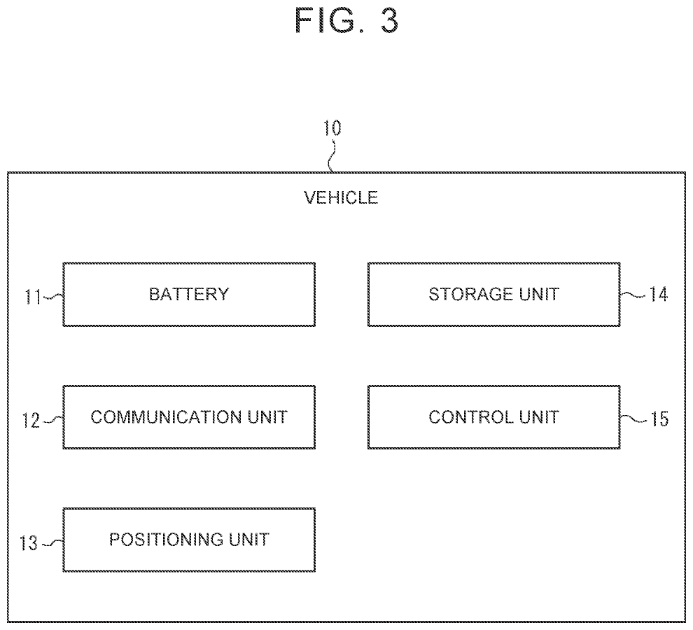

As illustrated in FIG. 3, the vehicle 10 includes a battery 11, a communication unit 12, a positioning unit 13, a storage unit 14, and a control unit (a controller) 15.

The battery 11 includes one or more secondary batteries. Examples of the secondary battery include, but not limited to, a lithium ion battery, a nickel-metal hydride battery, and a lead-acid battery. Each secondary battery in the battery 11 may function as a drive battery or an auxiliary battery.

The communication unit 12 includes one or more communication interfaces to be connected to the network 30. For example, the communication interface supports, but not limited to, a 4th generation (4G) or 5th generation (5G) mobile communication standard. In the present embodiment, the vehicle 10 communicates with the information processing device 20 via the communication unit 12 and the network 30.

The positioning unit 13 includes one or more devices configured to acquire position information of the vehicle 10. Specifically, the positioning unit 13 includes a receiver adapted to the Global Positioning System (GPS), but the receiver is not limited to such a receiver. The positioning unit 13 may include a receiver adapted to any satellite positioning system.

The storage unit 14 includes one or more memories. Examples of the memory include, but not limited to, a semiconductor memory, a magnetic memory, and an optical memory. For example, each memory in the storage unit 14 may function as a main storage device, an auxiliary storage device, or a cache memory. The storage unit 14 stores any information to be used for operations of the vehicle 10. For example, the storage unit 14 may store a system program, an application program, and embedded software. The information stored in the storage unit 14 may be updated with, for example, information acquired from the network 30 via the communication unit 12.

The control unit 15 includes one or more processors, one or more programmable circuits, one or more dedicated circuits, or a combination of these devices. The processor is, but not limited to, a general-purpose processor such as a central processing unit (CPU) or a graphics processing unit (GPU), or a dedicated processor specializing in a specific process. Examples of the programmable circuit include, but not limited to, a field-programmable gate array (FPGA). Examples of the dedicated circuit include, but not limited to, an application-specific integrated circuit (ASIC). The control unit 15 controls overall operations of the vehicle 10.

Configuration of Information Processing Device

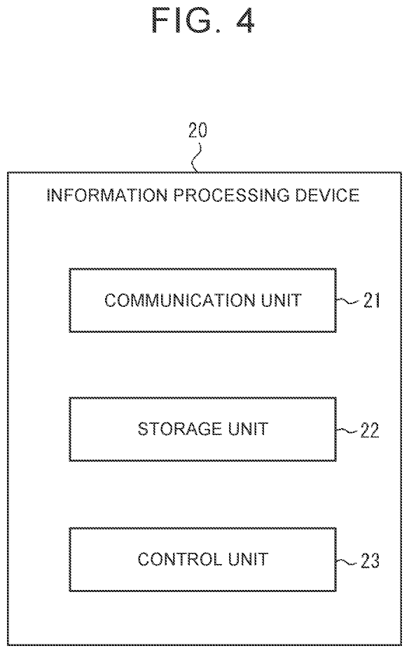

As illustrated in FIG. 4, the information processing device 20 includes a communication unit 21, a storage unit 22, and a control unit (a controller) 23.

The communication unit 21 includes one or more communication interfaces to be connected to the network 30. For example, the communication interface supports a mobile communication standard, a wired local area network (LAN) standard, or a wireless LAN standard, but the communication standard is not limited to these standards. The communication interface may support any other communication standard. In the present embodiment, the information processing device 20 communicates with each vehicle 10 via the communication unit 21 and the network 30.

The storage unit 22 includes one or more memories. For example, each memory in the storage unit 22 may function as a main storage device, an auxiliary storage device, or a cache memory. The storage unit 22 stores any information to be used for operations of the information processing device 20. For example, the storage unit 22 may store a system program, an application program, a database, and map information. The information stored in the storage unit 22 may be updated with, for example, information acquired from the network 30 via the communication unit 21.

The control unit 23 includes one or more processors, one or more programmable circuits, one or more dedicated circuits, or a combination of these devices. The control unit 23 controls overall operations of the information processing device 20.

Operation Flow of Information Processing Device

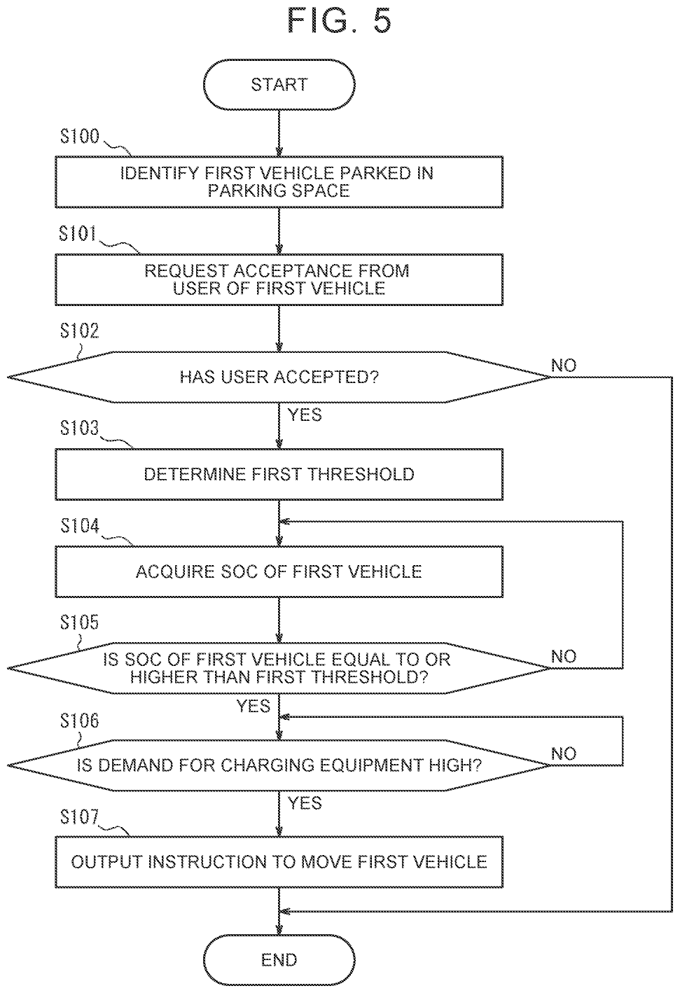

Next, operations of the information processing device 20 according to the present embodiment will be described with reference to FIG. 5.

Step S100: The control unit 23 of the information processing device 20 identifies, as the first vehicle 10, a vehicle 10 parked in the parking space 40 provided with the charging equipment 50.

Specifically, the control unit 23 acquires position information of the vehicle 10 from the vehicle 10 via the communication unit 21. When the position information of the parking space 40 prestored in the storage unit 22 and the position information of the vehicle 10 substantially agree with each other continuously for a predetermined period, the control unit 23 determines that the vehicle 10 is parked in the parking space 40, and identifies the vehicle 10 as the first vehicle 10. The first vehicle 10 may be identified not only by the method described above, but also by any other method. The first vehicle 10 parked in the parking space 40 may use the charging equipment 50, but need not use the charging equipment 50.

Step S101: The control unit 23 requests a user of the first vehicle 10 to accept movement of the first vehicle 10 from the parking space 40.

Specifically, the control unit 23 transmits a predetermined message via the communication unit 21 to the vehicle 10 or to an e-mail address or a user account of the user of the first vehicle 10 that is prestored in the storage unit 22. For example, the message is a message for asking the user to accept the movement of the first vehicle 10 from the parking space 40, but may be set as appropriate.

Step S102: The control unit 23 determines whether the user of the first vehicle 10 has accepted. When the user has accepted (Step S102: Yes), the process proceeds to Step S103. When the user has not accepted (Step S102: No), the process is terminated.

Specifically, the control unit 23 determines that the user has accepted when the control unit 23 acquires a response to accept the request in Step S101 from the user of the first vehicle 10. The control unit 23 determines that the user has not accepted when the control unit 23 acquires a response to decline from the user of the first vehicle 10 or when no response is acquired from the user of the first vehicle 10 continuously for a predetermined period.

Step S103: When determination is made in Step S102 that the user of the first vehicle 10 has accepted (Step S102: Yes), the control unit 23 determines a first threshold to be used for comparison with an SOC of the first vehicle 10.

The first threshold is a value of zero or more and 100 or less. Any method may be adopted to determine the first threshold. For example, the control unit 23 may determine a predetermined value (for example, 80) as the first threshold. Alternatively, the control unit 23 may determine the first threshold based on a future usage schedule or a past usage record of the first vehicle 10 that is prestored in the storage unit 22 or acquired from the first vehicle 10 via the communication unit 21.

For example, the control unit 23 acquires an estimated SOC to be consumed in a period from a time when the first vehicle 10 leaves the parking space 40 to a time when the first vehicle 10 is charged next (hereinafter referred to also as “estimated SOC consumption”) based on the future usage schedule of the first vehicle 10. Any method may be adopted to acquire the estimated SOC consumption based on the usage schedule. For example, it is assumed that the usage schedule indicates a date and time when the first vehicle 10 will be charged next, and one or more movement schedules each including a departure place and a destination. The control unit 23 may calculate a moving distance in a case where the first vehicle 10 moves in accordance with a movement schedule up to the date and time when the first vehicle 10 will be charged next. The control unit 23 may acquire the estimated SOC consumption based on the moving distance and fuel efficiency information of the first vehicle 10 that is prestored in the storage unit 22 or acquired from the first vehicle 10 via the communication unit 21. The method for acquiring the estimated SOC consumption based on the usage schedule is not limited to the method described above. The control unit 23 may determine the estimated SOC consumption as the first threshold, or may determine a value larger than the estimated SOC consumption and equal to or smaller than 100 as the first threshold.

Alternatively, the control unit 23 acquires the estimated SOC consumption based on the past usage record of the first vehicle 10. Any method may be adopted to acquire the estimated SOC consumption based on the usage record. For example, the control unit 23 estimates a future usage schedule of the first vehicle 10 based on the past usage record of the first vehicle 10. For example, it is assumed that the usage record indicates a period during which the first vehicle 10 is charged, and one or more movement records each including a departure place and a destination. When the usage record of the first vehicle 10 has periodicity (for example, when weekly usage records are substantially the same), the control unit 23 may estimate the future usage schedule of the first vehicle 10 based on the periodicity of the usage record. The control unit 23 may acquire the estimated SOC consumption by the method described above based on the estimated usage schedule, and determine the first threshold based on the estimated SOC consumption.

Step S104: The control unit 23 acquires a current SOC of the first vehicle 10 from the first vehicle 10 via the communication unit 21.

Step S105: The control unit 23 determines whether the SOC of the first vehicle 10 acquired in Step S104 is equal to or higher than the first threshold determined in Step S103. When determination is made that the SOC of the first vehicle 10 is equal to or higher than the first threshold (Step S105: Yes), the process proceeds to Step S106. When determination is made that the SOC of the first vehicle 10 is lower than the first threshold (Step S105: No), the process returns to Step S104.

Step S106: When determination is made in Step S105 that the SOC of the first vehicle 10 is equal to or higher than the first threshold, the control unit 23 determines whether a future demand for the charging equipment 50 is high in light of a predetermined criterion. When determination is made that the future demand for the charging equipment 50 is high (Step S106: Yes), the process proceeds to Step S107. When determination is made that the future demand for the charging equipment 50 is low (Step S106: No), the process repeats Step S106.

Any method may be adopted to determine whether the future demand for the charging equipment 50 is high. For example, the control unit 23 may acquire information indicating whether the future demand for the charging equipment 50 is high via the communication unit 21 from an external server connected to the network 30. Alternatively, when the system 1 includes a plurality of vehicles 10, the control unit 23 may determine whether the future demand for the charging equipment 50 is high based on pieces of information acquired from the vehicles 10.

A first specific example will be described. The control unit 23 acquires, from a plurality of vehicles 10 except the first vehicle 10, pieces of position information of the vehicles 10, SOCs of the vehicles 10, and pieces of destination information set in route guidance. Based on the acquired pieces of information, the control unit 23 acquires the number of vehicles 10 heading for an area including the parking space 40 (for example, a parking lot, a facility, or a town) with their current SOCs or predicted SOCs at the time of arrival at the area being lower than a second threshold (hereinafter referred to also as “second vehicles 10”). When the number of second vehicles 10 is equal to or larger than a first specified number (for example, one), the control unit 23 determines that the future demand for the charging equipment 50 is high.

A second specific example will be described. The control unit 23 acquires, from a plurality of vehicles 10 except the first vehicle 10, future usage schedules of the vehicles 10. Based on the acquired usage schedules, the control unit 23 acquires the number of vehicles 10 expected to use the charging equipment 50 in a predetermined time frame in the future (hereinafter referred to also as “third vehicles 10”). When the number of third vehicles 10 is equal to or larger than a second specified number (for example, 10), the control unit 23 determines that the future demand for the charging equipment 50 is high.

The first specific example and the second specific example of the method for determining the future demand for the charging equipment 50 may be combined together. In such a case, the control unit 23 determines that the future demand for the charging equipment 50 is high when the number of second vehicles 10 is equal to or larger than the first specified number or when the number of third vehicles 10 is equal to or larger than the second specified value.

Step S107: When determination is made in Step S106 that the future demand for the charging equipment 50 is high (Step S106: Yes), the control unit 23 outputs an instruction to move the first vehicle 10 from the parking space 40. Then, the process is terminated.

Details of the instruction and the output destination may be set as appropriate. For example, it is assumed that the first vehicle 10 can autonomously be driven based on an instruction from the information processing device 20. The control unit 23 outputs the instruction to the first vehicle 10 via the communication unit 21. The first vehicle 10 moves from the parking space 40 by autonomous driving based on the instruction. In such a case, the instruction may include any information to be used for the autonomous driving by which the first vehicle 10 moves from the parking space 40. For example, it is assumed that the first vehicle 10 can be driven manually. The control unit 23 outputs the instruction to a computer of a manager of the parking space 40 via the communication unit 21. For example, the instruction may include an electronic key for driving the first vehicle 10. The manager of the parking space 40 drives the first vehicle 10 based on the instruction to move the first vehicle 10 from the parking space 40.

The instruction may include information indicating a movement destination of the first vehicle 10.

When the first specific example is implemented as the method for determining the future demand for the charging equipment 50 in Step S106, the control unit 23 may acquire estimated times when the second vehicles 10 will arrive at the area including the parking space 40. The control unit 23 may output an instruction to move the first vehicle 10 from the parking space 40 before the earliest estimated time among the estimated times of the second vehicles 10.

When the second specific example is implemented as the method for determining the future demand for the charging equipment 50 in Step S106, the control unit 23 may output an instruction to move the first vehicle 10 from the parking space 40 before the predetermined time frame when the third vehicles 10 are expected to use the charging equipment 50.

The information processing device 20 according to the present embodiment described above determines whether the SOC of the first vehicle 10 parked in the parking space 40 provided with the charging equipment 50 is equal to or higher than the first threshold. The information processing device 20 determines whether the future demand for the charging equipment 50 is high in light of the predetermined criterion. When the information processing device 20 determines that the SOC of the first vehicle 10 is equal to or higher than the first threshold and the future demand for the charging equipment 50 is high, the information processing device 20 outputs an instruction to move the first vehicle 10 from the parking space 40.

According to the configuration described above, when the SOC of the first vehicle 10 parked in the parking space 40 is relatively high and the future demand for the charging equipment 50 is high, the first vehicle 10 may be moved from the parking space 40 to a different place. Therefore, the technology related to charging of the vehicles 10 is improved, for example, in that a necessary and sufficient SOC can be secured for the first vehicle 10 and the system can fulfill the future demand for the charging equipment 50.

Although the present disclosure has been described based on the drawings and embodiment, it should be noted that those skilled in the art may make various modifications and changes based on the present disclosure. It should therefore be noted that these modifications and changes fall within the scope of the present disclosure. For example, the functions included in the components, steps, or the like may be rearranged so as not to cause logical inconsistency, and a plurality of components, steps, or the like may be combined into a unit or divided apart from each other.

For example, in the embodiment described above, the configuration and operation of the information processing device 20 may be distributed among a plurality of computers that can communicate with each other. For example, there may be adopted an embodiment in which the components of the information processing device 20 are partially or entirely provided in the vehicle 10 or the charging equipment 50.

The order of the operations of Steps S100 to S107 of the information processing device 20 may be changed within a range that causes no logical inconsistency. For example, the order of Step S101 for requesting acceptance from the user of the first vehicle 10 and Step S102 for determining whether the user has accepted may be set as appropriate as long as these steps are executed before Step S107. Similarly to the embodiment described above, the information processing device 20 does not output an instruction to move the first vehicle 10 from the parking space 40 unless the user of the first vehicle 10 has accepted.

For example, there may be adopted an embodiment in which a general-purpose computer functions as the information processing device 20 according to the embodiment described above. Specifically, a program describing details of processes that implement the functions of the information processing device 20 according to the embodiment described above is stored in a memory of the general-purpose computer, and is read and executed by a processor. Therefore, the disclosure according to the present embodiment can also be realized as a program that can be executed by a processor or as a non-transitory computer-readable medium that stores the program.

What is claimed is:

1. A method to be executed by an information processing device, the method comprising:
determining whether a state of charge of a first vehicle parked in a parking space provided with charging equipment is equal to or higher than a first threshold;
determining whether a future demand for the charging equipment is high based on a predetermined criterion; and
outputting an instruction to move the first vehicle from the parking space when determining that the state of charge of the first vehicle is equal to or higher than the first threshold and the future demand for the charging equipment is high.

2. The method according to claim 1, further comprising:
acquiring the number of second vehicles heading for an area including the parking space the second vehicles each having a current state of charge or a predicted state of charge at a time of arrival at the area lower than a second threshold; and
determining that the future demand for the charging equipment is high when the number of the second vehicles is equal to or larger than a first specified number.

3. The method according to claim 2, wherein the instruction includes an instruction to move the first vehicle from the parking space before estimated times when the second vehicles arrive at the area.

4. The method according to claim 1, further comprising:
acquiring the number of third vehicles expected to use the charging equipment in a predetermined time frame in a future; and
determining that the future demand for the charging equipment is high when the number of the third vehicles is equal to or larger than a second specified number.

5. The method according to claim 4, wherein the instruction includes an instruction to move the first vehicle from the parking space before the predetermined time frame.

6. The method according to claim 1, further comprising:
requesting a user of the first vehicle to accept movement of the first vehicle from the parking space; and
not outputting the instruction when the user has not accepted.

7. The method according to claim 1, further comprising determining the first threshold based on a future usage schedule or a past usage record of the first vehicle.

8. An information processing device comprising a controller configured to:
determine whether a state of charge of a first vehicle parked in a parking space provided with charging equipment is equal to or higher than a first threshold;
determine whether a future demand for the charging equipment is high based on a predetermined criterion; and
output an instruction to move the first vehicle from the parking space when determining that the state of charge of the first vehicle is equal to or higher than the first threshold and the future demand for the charging equipment is high.

9. The information processing device according to claim 8, wherein the controller is configured to:
acquire the number of second vehicles heading for an area including the parking space the second vehicles each having a current state of charge or a predicted state of charge at a time of arrival at the area lower than a second threshold; and
determine that the future demand for the charging equipment is high when the number of the second vehicles is equal to or larger than a first specified number.

10. The information processing device according to claim 9, wherein the controller is configured to output, as the instruction, an instruction to move the first vehicle from the parking space before estimated times when the second vehicles arrive at the area.

11. The information processing device according to claim 8, wherein the controller is configured to:
acquire the number of third vehicles expected to use the charging equipment in a predetermined time frame in a future; and
determine that the future demand for the charging equipment is high when the number of the third vehicles is equal to or larger than a second specified number.

12. The information processing device according to claim 11, wherein the controller is configured to output, as the instruction, an instruction to move the first vehicle from the parking space before the predetermined time frame.

13. The information processing device according to claim 8, wherein:
the controller is configured to request a user of the first vehicle to accept movement of the first vehicle from the parking space; and
the controller is configured not to output the instruction when the user has not accepted.

14. The information processing device according to claim 8, wherein the controller is configured to determine the first threshold based on a future usage schedule or a past usage record of the first vehicle.

15. A non-transitory storage medium storing a program that is executable by a computer and that causes the computer to perform functions comprising:
determining whether a state of charge of a first vehicle parked in a parking space provided with charging equipment is equal to or higher than a first threshold;
determining whether a future demand for the charging equipment is high based on a predetermined criterion; and
outputting an instruction to move the first vehicle from the parking space when determining that the state of charge of the first vehicle is equal to or higher than the first threshold and the future demand for the charging equipment is high.

16. The non-transitory storage medium according to claim 15, wherein the functions further comprise:
acquiring the number of second vehicles heading for an area including the parking space the second vehicles each having a current state of charge or a predicted state of charge at a time of arrival at the area lower than a second threshold; and
determining that the future demand for the charging equipment is high when the number of the second vehicles is equal to or larger than a first specified number.

17. The non-transitory storage medium according to claim 16, wherein the instruction includes an instruction to move the first vehicle from the parking space before estimated times when the second vehicles arrive at the area.

18. The non-transitory storage medium according to claim 15, wherein the functions further comprise:
acquiring the number of third vehicles expected to use the charging equipment in a predetermined time frame in a future; and
determining that the future demand for the charging equipment is high when the number of the third vehicles is equal to or larger than a second specified number.

19. The non-transitory storage medium according to claim 18, wherein the instruction includes an instruction to move the first vehicle from the parking space before the predetermined time frame.

20. The non-transitory storage medium according to claim 15, wherein the functions further comprise:
requesting a user of the first vehicle to accept movement of the first vehicle from the parking space; and
not outputting the instruction when the user has not accepted.
